(19) United States
(12) Patent Application Publication
(10) Pub. No.: US 2026/0258516 A1
(43) Pub. Date: Sep. 3, 2026

(54) A method for manufacturing pig iron in a production line comprising an electrical smelting furnace

(71) Applicant: ArcelorMittal, Luxembourg (LU)

(72) Inventors: Jean-Christophe HUBER, Vry (FR); Simon Pierre DEPLECHIN, Mouscron (BE); Mathieu SANCHEZ, Plappeville (FR)

(21) Appl. No.: 18/994,759

(22) PCT Filed: Jul. 29, 2022
(86) PCT No.: PCT/IB2022/057044

§ 371 Date: Jan. 15, 2025

(51) Int. Cl. C21C 1/02; C21B 11/10

(52) U.S. Cl. CPC C21C 1/025; C21B 11/10

(57) ABSTRACT

A method for manufacturing pig iron in a smelting furnace including a vessel, the method including the following successive steps: loading DRI product in the vessel, melting the DRI product to form a pig iron layer topped by a slag layer, transferring the pig iron to the desulphurization station, and injecting a silicon containing material in the pig iron in the desulphurization station. It also deals with the manufacturing of steel from the iron.

The present invention is related to a method of manufacturing pig iron, also called hot metal and to a method of producing steel out of such pig iron.

### BACKGROUND

Currently, Steel can be produced through two main manufacturing routes. Nowadays, the most commonly used production route named “BF-BOF route” consists in producing hot metal in a blast furnace, by use of a reducing agent, mainly coke, to reduce iron oxides and then transform hot metal into steel into a converter process or Basic Oxygen furnace (BOF). This route, both in the production of coke from coal in a coking plant and in the production of the hot metal, releases significant quantities of CO_{2.}

The second main route involves so-called “direct reduction methods”. Among them are methods according to the brands MIDREX®, FINMET®, ENERGIRON®/HYL, COREX®, FINEX® etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI undergoes further processing in electric furnaces to produce steel.

### SUMMARY OF THE INVENTION

One of the main options chosen by steelmakers to reduce CO₂ emissions is therefore to switch from the BF-BOF route towards the DRI route. However, use of DRI products in classical electrical furnaces together with ferrous scraps has some limitations. Indeed, scraps contain a lot of impurities and resulting liquid steel will need to be further processed to produce high quality steel grades. Investment on new liquid steel treatment tools would thus be necessary.

An aim of the present invention is [[therefore]] to remedy the drawbacks of the pig iron and steelmaking manufacturing routes by providing a new route efficiently minimizing the environmental impact of such manufacturing.

The present invention provides a method for manufacturing pig iron in a production line comprising an electrical smelting furnace including a vessel, and a desulphurization station, said method comprising the following successive steps:
loading DRI product in said vessel;
melting said DRI product to form a pig iron layer topped by a slag layer;
transferring said pig iron to said desulphurization station; and
injecting a silicon containing material in said pig iron in said desulphurization station.

The present invention provides a method for manufacturing steel wherein pig iron manufactured according to the method described above is transferred from said smelting furnace to a converter wherein the carbon content of said pig iron is then lowered to a value below 2.1 percent in weight by oxygen blowing, so as to obtain liquid steel.

### BRIEF DESCRIPTION OF THE DRAWINGS

Other characteristics and advantages of the present invention will emerge clearly from the description of it that is given below by way of an indication and which is in no way restrictive, with reference to the appended figures in which:

FIG. 1 illustrates schematically a pig iron and steelmaking process according to the smelting/BOF route, and

FIG. 2 illustrates schematically a smelting furnace.

Elements in the figures are illustrations and may not have been drawn to scale.

### DETAILED DESCRIPTION

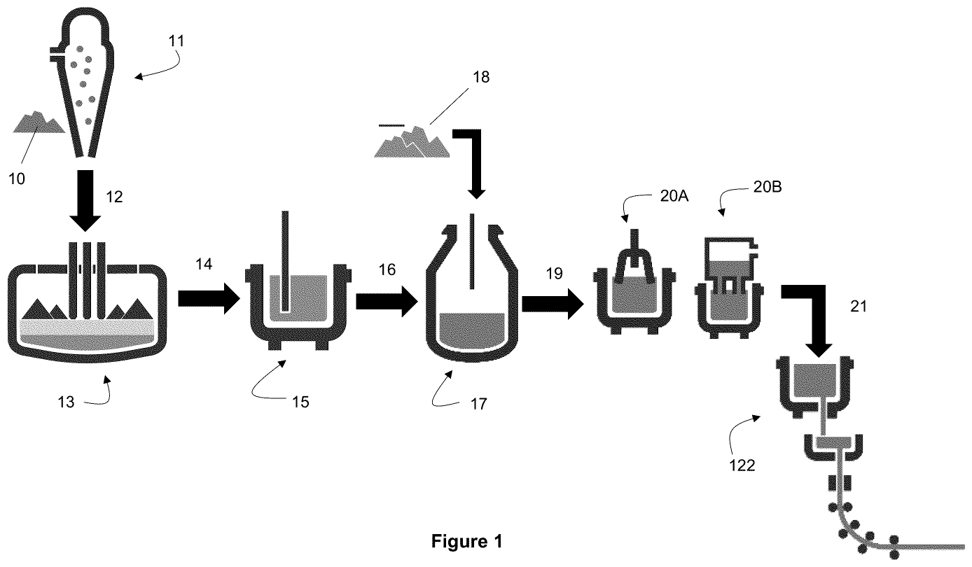

FIG. 1 illustrates schematically a steel production route according to the DRI route, from the reduction of iron to the casting of the steel into semi-products such as slabs, billets, blooms, or strips. Iron ore 10 is first reduced in a direct reduction plant 11. This direct reduction plant 11 may be designed to implement any kind of direct reduction technology such as MIDREX® technology or Energiron®. The direct reduction process may for example be a traditional natural-gas or a biogas-based process.

In a preferred embodiment, the DRI product used in the method according to the present invention is manufactured using a reducing gas based on biogas coming from combustion of biomass.

Biomass is renewable organic material that comes from plants and animals. Biomass sources include notably wood and wood processing wastes such as firewood, wood pellets, and wood chips, lumber and furniture mill sawdust and waste, and black liquor from pulp and paper mills, agricultural crops and waste materials such as corn, soybeans, sugar cane, switchgrass, woody plants, and algae, and crop and food processing residues, but also biogenic materials in municipal solid waste such as paper, cotton, and wool products, and food, yard, and wood wastes, animal manure and human sewage. In the sense of the present invention, biomass may also encompass plastics residues, such as recycled waste plastics like Solid Refuse Fuels or SRF.

Whenever using natural gas or biogas as reducing gas, the carbon content of the DRI product can be set to a maximum of 3 % in weight and usually to a range of 2 to 3% in weight.

In another preferred embodiment, the DRI product used in the method according to the present invention is manufactured through a so called H₂-DRI process where the reducing gas comprises more than 50 % and preferably more than 60, 70, 80 or 90 % in volume of hydrogen or is even entirely made of hydrogen. The H₂-DRI product will contain a far lower level of carbon than the natural gas or biogas DRI, so typically below 1% in weight or even lower. In a preferred embodiment, the hydrogen used in the DRI reducing gas comes from the electrolysis of water, which is preferably powered in part or all by CO₂ neutral electricity. CO₂ neutral electricity includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced.

Whichever DRI process is used, the resulting Direct Reduced Iron (DRI) Product 12 is then charged into a smelting furnace 13 where the reduction of iron oxide is completed, and the product is melted to produce pig iron.

The DRI product can be transferred to the smelting furnace in various forms. Preferably, the directly reduced iron product (DRI product) is fed to the smelting furnace in a hot form as HDRI product (so-called Hot DRI), or in a cold form as CDRI product (so-called Cold DRI), or in hot briquette form as HBI product (so-called Hot Briquetted Iron) and/or in particulate form, preferably with an average particle diameter of at most 10.0 mm, more preferably with an average particle diameter of at most 5.0 mm.

It is preferably charged directly at the exit of the direct reduction plant 11 as a hot product with a temperature from 500° C. to 700° C. This allows reducing the amount of energy needed to melt it. When hot charging is not possible, for example if the direct reduction plant 11 and the smelting furnace 13 are not on same location, or if the smelting furnace 13 is stopped for maintenance and thus DRI product must be stored, then the DRI product may be charged cold, or a preheating step may be performed.

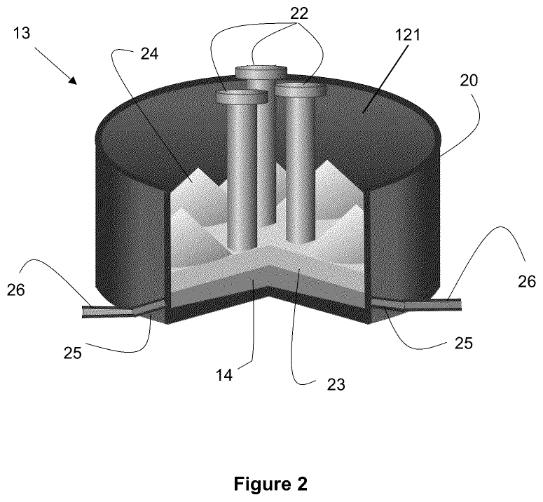

The smelting furnace 13 uses electric energy provided by several electrodes 22 to melt the DRI product 12 and produce a pig iron 14. In a preferred embodiment, part or all of the electricity needed comes from CO₂ neutral electricity. Further detailed description of the smelting furnace will be given later, based on FIG. 2.

The pig iron 14 is then transferred to a pig iron ladle through at least one tap hole 25 provided with at least one runner 26. Such tap holes 25 are located in the lower part of the vessel 20. They may be located in the lateral walls of the vessel or in its bottom wall. There are usually as many auxiliary runners as tap holes, said runners then intersecting to form a main runner to lead the extracted pig iron to the pig iron ladle.

This pig iron ladle may be a simple ladle but could also be a torpedo ladle.

The pig iron 14 is sent to a desulphurization station 15 to perform a desulphurization step. This desulphurization step may be performed in a dedicated vessel or preferentially directly in the pig iron ladle to avoid molten metal transfer and associated heat losses. This desulphurization step is needed for production of steel grades requiring a low Sulphur content, which is, for example set at a maximum of 0.03 weight percent of sulphur. Desulfurization in oxidizing conditions is not effective and is thus preferentially performed either on pig iron before oxygen refining, or in steel ladle after steel deoxidizing. For very low sulfur contents, for example below 0.004 weight percent of sulfur, deoxidizing and desulphurization are combined for overall higher performance. Low sulfur grades thus benefit from performing pig iron desulfurization before the conversion step.

Desulphurization of the pig iron can be done by adding reagents, notably based on calcium or magnesium compounds, such as sodium carbonate, lime, calcium carbide, and/or magnesium into the pig iron. It may be done for example by injection of those reagents in the pig iron ladle. The desulphurized pig iron 16 has preferentially a content of Sulphur lower than 0.03 % in weight and preferably lower than 0.004 % in weight.

The desulphurized pig iron 16 can then transferred into a converter 17. The converter basically turns the molten metal into liquid steel by blowing oxygen through molten metal to decarburize it. It is commonly named Basic Oxygen Furnace (BOF). Ferrous scraps 18, coming from recycling of steel, may also be charged into the converter 17 to take benefit of the heat released by the exothermic reactions resulting from the oxygen injection into pig iron.

Liquid steel 19 thus formed can then be transferred, whenever needed, to one or more secondary metallurgy tools 20A, 20B such as Ladle furnaces, RH (Ruhrstahl-Heareus) vacuum vessel, Vacuum Tank degasser, alloying and stirring stations, et cetera to be treated to reach the required steel composition according to the steel grades to be produced. Liquid steel with the required composition 21 can then be transferred to a casting plant 122 where it can be turned into solid products, such as slabs, billets, blooms, or strips.

As shown schematically in FIG. 2, the smelting furnace 13 is composed of a vessel 20 able to contain hot metal. The vessel 20 may have circular or a rectangular shape, for example. This vessel 20 is closed by a roof 121 (shown schematically in FIG. 2) provided with some apertures to receive electrodes 22 to be inserted into the vessel 20 and with other apertures to allow charging of the raw materials into the vessel 20.

The electrodes 22 provide the required electric energy to melt the charged raw materials and form pig iron. They are preferably Söderberg-type electrodes.

During the melting of the raw materials, two layers are formed, a pig iron 14 layer which is the densest and is thus located at the bottom of the vessel 20 and a slag layer 23 located above the pig iron 14. The slag layer 23 can be partially covered by piles of raw materials 24 waiting to be melted.

The vessel 20 is also provided with apertures named tap tape holes 25 located in its lower part and allowing to discharge the pig iron 14 while keeping most of the slag into the vessel 20. They may be located in the lateral walls of the vessel or in its bottom wall.

The smelting furnace 13 may be a SAF (Submerged-Arc Furnace) wherein the electrodes are immersed into the slag layer 23 or an OSBF (open-slag bath furnace) wherein the electrodes 22 are located above the slag layer 23. It is preferentially an OSBF as illustrated in the figures.

In the frame of the present invention, a silicon containing material is added to the pig iron in the desulphurization station 15. This addition can be done though an injection device. Silicon has a strong deoxidizing power at high temperature and notably around 1600° C. which is the temperature of the liquid steel in the converter. It reacts with oxygen and contributes then to the formation of the slag in the converter. The reaction is exothermic and therefore provides additional energy for scrap melting. The more scrap is used, the smaller the environmental footprint of the process.

By injecting silicon in the pig iron at that stage, it has been observed by the present inventors that it allows full dissolution of the silicon with a good yield before the pig iron reaches the converter 17. Moreover, this addition is improving the desulphurization process efficiency by maintaining strong local deoxidizing conditions.

In a preferred embodiment, the injection is done with the lance usually used for injecting desulphurizing reagents. It is then added with a carrier-gas. This gas is preferably inert and may be made of nitrogen, argon, helium or carbon monoxide or any mixtures of such gases.

Such silicon can be added under different forms. It may be metal Silicon Si, silicon carbide SiC, silicomanganese SiMn, calcium silicate SiCa or a ferro silicon alloy FeSi such as FeSi75 or FeSi65.

The use of DRI products in the smelting furnace 13 will lead to a natural amount of silicon usually below 0.2 or even below 0.1 % in weight. The final silicon content of the pig iron is preferentially set at a value of 0.1 to 0.4% in weight, preferably of 0.2 to 0.4 % in weight. Further additions of silicon in the converter 17 may be performed if required.

In a preferred embodiment, carbon containing material may be injected together with the silicon containing material in the desulphurization station 15.

As explained above, the carbon content of the pig iron 14 produced through the DRI route will generally be lower than 3 % in weight. However, to fulfil the requirements of the subsequent steelmaking process at the converter, the pig iron should preferably have a carbon content as close as possible to 4.5% in weight, which is the level of saturation. In a preferred embodiment, the pig iron carbon content is in the range of 4.0 to 4.5% in weight.

Indeed, carbon is necessary for the steelmaking process performed in the converter 17 through oxygen blowing. This is because the reaction of carbon with oxygen creates carbon monoxide gas, which provides intense and efficient stirring of the molten metal and thus improves the removal of impurities from the steel. This reaction is exothermic and therefore provides additional energy for ferrous scraps melting, allowing to incorporate a higher amount of such ferrous scraps coming from steel recycling. The more ferrous scraps used, the smaller the environmental footprint of the steelmaking process.

The carbon containing material may come from different sources. It may be chosen, for example, among coke, anthracite, silicon carbide, calcium carbide, or a mixture of any of those sources, but can also advantageously come from renewable sources like biomass for part or all the carbon loads. In particular, biochar can be used. Adding calcium carbide is particularly advantageous as the calcium atoms can provide a desulphurizing effect.

In another embodiment, the carbon containing material may also be made of composite briquettes of an iron source mixed with one or several of the previously mentioned carbon sources.

In a preferred embodiment, the iron source can be chosen among sludges from electric furnaces, converters or smelters, slags from electric furnaces or from converters or any waste rich in iron from steel production route.

Adding silicon carbide is particularly advantageous as it allows increasing the carbon content of the pig iron on top of adding silicon. Adding a mix of calcium carbide and silicon carbide is even more advantageous as it provides carbon and silicon addition, while ensuring desulphurization.

What is claimed is:

1-9. (canceled)

10. A method for manufacturing pig iron in a production line comprising an electrical smelting furnace including a vessel and a desulphurization station, the method comprising the following successive steps:
loading DRI product in the vessel;
melting the DRI product to form a pig iron layer topped by a slag layer;
transferring the pig iron to the desulphurization station; and
injecting a silicon containing material in the pig iron in the desulphurization station.

11. The method according to claim 10 wherein the silicon containing material is injected in an amount sufficient to reach a final silicon content of 0.1 to 0.4% in weight in the pig iron.

12. The method according to claim 10 wherein the silicon containing material is injected with a carrier-gas.

13. The method according to claim 10 wherein the silicon containing material is chosen from at least one of the group consisting of: metal Silicon Si, silicon carbide SiC, silicomanganese SiMn, calcium silicate SiCa, ferro silicon alloy FeSi and a mixture of any of those materials.

14. The method according to claim 10 wherein the silicon containing material is injected has particles, the particles having a particle size below 3 mm.

15. The method according to claim 10 wherein the DRI product is manufactured using a reducing gas containing at least 50 % in volume of hydrogen before being loaded in the smelting furnace.

16. The method according to claim 10 wherein a carbon containing material is added to the silicon containing material to be injected in the pig iron.

17. A method for manufacturing steel employing the method as recited in claim 10 comprising the steps of:
transferring the pig iron from the smelting furnace to a converter; and
lowering a carbon content of the pig iron to a value below 2.1 percent in weight by blowing oxygen to obtain liquid steel.

18. The method for manufacturing steel according to claim 17 wherein ferrous scraps are added to the pig iron in the converter, the ferrous scraps being melted.
